(19) United States
(12) Patent Application Publication
(10) Pub. No.: US 2008/0320386 A1
(43) Pub. Date: Dec. 25, 2008

(54) Methods for optimizing the layout and printing of pages of Digital publications.

(75) Inventors: Bertrand J. Balzano, Dallas, TX (US); Claudie Clot, Dallas, TX (US)

Correspondence Address: ADVANCIS.COM, INC, 2911 TRULTE CREEK BLVD , SUITE 300, DALLAS, TX, 75219, US

(73) Assignee: advancis.com, Inc., Dallas, TX (US)

(21) Appl. No.: 11/875,839

(22) Filed: Oct. 20, 2007

Related U.S. Application Data
(60) Provisional application No. 60/945,906, filed on Jun. 23, 2007.

(51) Int. Cl. G06F 17/24; G06F 3/048

(52) U.S. Cl. 715/256; 715/273; 715/764

(57) ABSTRACT

Systems, methods, graphical user interface elements and other implementations are described for optimizing the layout and printing of pages of digital publications to improve legibility of key content while preserving the layout (e.g. without materially altering the position and size of the bounding boxes of content elements featured on the pages) of the printed format (e.g. print version of the publication on which the digital publication is based) hereby ensuring that the advertising space and or space reserved for images and graphics, among others, defined in the printed version remain unchanged. The invention also consisting of methods for printing the resulting, reformatted digital publication.

### REFERENCES

This application claims the benefit of U.S. Provisional Patent Application US60/945,906, filed on Jun. 23, 2007, entitled “Methods for optimizing the layout and printing of pages of Digital publications”.

Other patents referenced in this application include:

U.S. Patent Documents

U.S. Pat. No. 6,915,484 Jul. 5, 2005 Ayers, et al.

### BACKGROUND

1. Field of Invention

The present invention relates generally to digital publications that are displayed on the screen of a computer or on the screen of a mobile device or other display. While some digital publications are self-contained computer applications, others must be run using another application to function properly and to be displayed on screen. The present invention relates to both types of digital publications and therefore also relates to said applications that may be referred to as a reader, plug-in or other multimedia player.

The term Digital publication is meant to encompass digital brochures, digital magazines, digital catalogs, digital newspapers, ebooks, eBrochures. eMagazines, eCatalogs eNewspapers, electronic brochures, electronic magazines, electronic catalogs, online brochures, online magazines, and online catalogs. The list represents a sample of the multitude of terms used in the marketplace to describe a digital publication and is in no way exhaustive.

2. Prior Art

Digital publications have become increasingly popular and prevalent in today's marketplace thanks in part to publishers' and marketers' desire to save on printing and shipping costs over printed publications. The advent of the Internet has further increased the popularity of the digital publication format because new Internet-based distribution channels meant that the circulation and reach of a digital publication could rival or surpass that of its paper counterpart.

In its simplest form, a digital publication consists of a set of pages presented in a single-or double-page view on a computer screen or mobile device screen whereby the user can navigate through the publication using the mouse, keyboard or other input device, in effect, simulating the act of reading of a paper publication. In recent years, more elaborate digital publications have been introduced further mimicking actual paper publications on screen whereby the reader is actually able to turn pages of the publication in a 3D or 2D environment.

Publishers of digital publications generally also offer a printed version of the publication from which the digital publication is derived (e.g. created).

The main challenge facing publishers of digital publications is legibility. Publishers who wish to create digital publications that are exact replicas, in terms of layout, of the printed versions are forced to present readers pages that are too difficult to read without zooming in and out of every page. Unfortunately, the need to continuously zoom hinders the reading experience and limits the amount of time a reader spends interacting with a digital publication. Since text is not legible, readers are forced to zoom in on sections of pages without knowing what the section is about. The resulting experience is not as engaging as reading a printed publication.

Until now, the only option publishers had to remedy the legibility problem was the reformat the digital publication (e.g. change its layout). However, this meant that the layouts for digital and printed versions of a publication were different, affecting advertising space and ad positions among other page elements.

More recent inventions (U.S. Pat. No. 6,915,484) have made it possible to reflow content while maintaining spatial relationships between content elements (text, graphics, etc . . . ). However, such methods involve moving and or stretching some graphical elements on a page to preserve said spatial relationships. As a result, the original layout is not preserved hereby affecting, among others, the advertising space and ad positions on the pages of the digital publication.

The present invention consists of systems, methods, graphical user interface elements and other implementations for converting a print publication into a digital publication while improving legibility of key content without altering the layout of printed format (e.g. printed version of the publication). The invention also consisting of methods for printing the resulting, reformatted publication.

3. Definitions

Herein after, the term “Print publication” refers to the file publishers send to presses to output a paper version of their publication.

4. Limited Copyright Waiver

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### SUMMARY OF THE INVENTION

Systems, methods, graphical user interface elements and other implementations are described for optimizing the layout and printing of pages of digital publications to improve legibility of key content while preserving the layout (e.g. without materially altering the position and size of the bounding boxes of content elements featured on the pages) of the printed format (e.g. print version of the publication on which the digital publication is based) hereby ensuring that the advertising space and or spaces reserved for images and graphics, among others, defined in the printed version remain unchanged. The invention also consisting of methods for printing the resulting, reformatted digital publication.

### BRIEF DESCRIPTION OF THE DRAWINGS

FIG. 1 illustrates a screenshot of an exemplary digital publication based on the print version of a publication.

FIG. 2 shows a screenshot of subsequent pages, page number four and page number five, of the exemplary digital publication illustrated in FIG. 1.

FIG. 3 illustrates a block diagram of a method that may be used to convert key textual content of a print publication into a format optimized for onscreen viewing.

FIG. 4 shows a screenshot of paragraph cells corresponding to the eBranding article on page number two and page number three of the digital publication.

FIG. 5 shows a screenshot of paragraph cells corresponding to the eBranding article on page number four and page number five of the digital publication.

FIG. 6 shows a screenshot of the textual content of the eBrand article after increasing the font size by a value of 145%.

FIG. 7 shows a screenshot of textual content of the eBrand article on pages number four and five after increasing its font size by a value of 145%.

FIG. 8 illustrates a screenshot of a user interface that may be used to display overset text and allow reader to interact with the overset text.

FIG. 9 illustrates a block diagram of a printing tool that can be used to print an optimized digital publication.

FIGS. 10A 10B 10C describe methods that may be used to print the content of said optimized digital publication.

### DESCRIPTION OF THE INVENTION

In the following detailed description, numerous specific details are set forth in order to provide a thorough understanding of the invention. However, it will be apparent to one of ordinary skill in the art that these specific details need not be used to practice the invention. In other instances, well known structures, interfaces, and processes have not been shown in detail in order not to unnecessarily obscure the invention.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein. Computer system can include peripherals such as a printer, a hard drive, mouse or other input device. Computer system can be connected to a network via wire or wirelessly.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, the invention can be realized in any processing device (e.g. a computer, a gaming device, a messaging device, a mobile phone, a personal/portable digital assistant (“PDA”), an embedded device, or any other device capable of displaying content) which runs an operating system.

The present invention consists of systems, methods, graphical user interface elements and other implementations for optimizing the layout and printing of pages of digital publications to improve legibility of key content while preserving the layout (e.g. without materially altering the position and size of the bounding boxes of content elements featured on the pages) of the printed format (e.g. print version of the publication on which the digital publication is based) hereby ensuring that the advertising space and or space reserved for images and graphics, among others, defined in the printed version remain unchanged. The invention also consisting of methods for printing the resulting, reformatted digital publication.

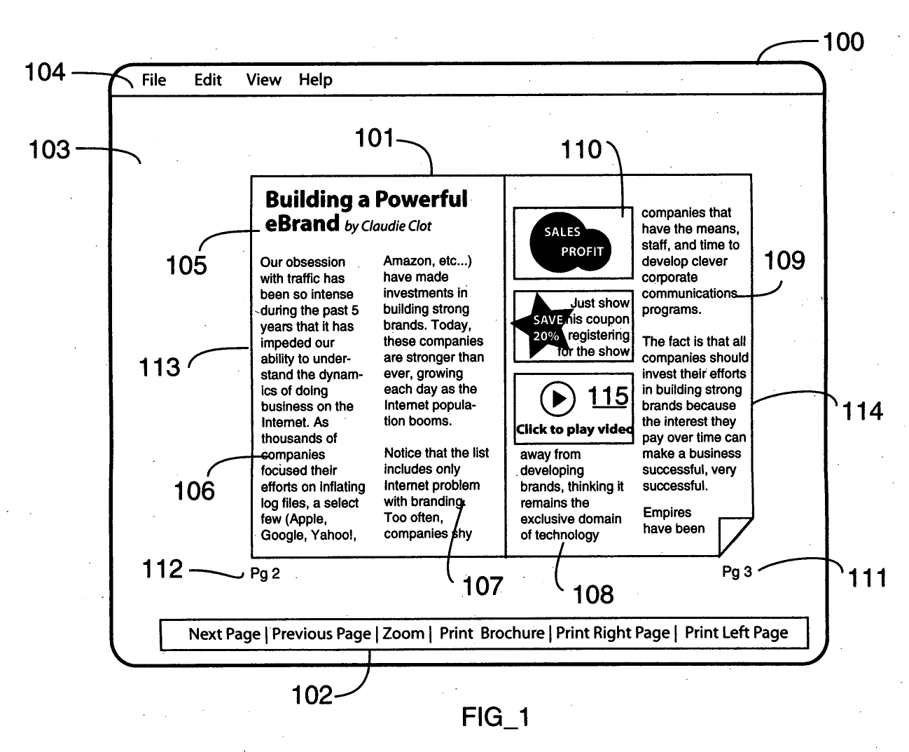

FIG. 1 illustrates a screenshot of an exemplary desktop user interface 100 with an exemplary digital publication 101 based on the print version of a publication (not shown). At this stage of the process, the layout of the digital publication 101 is essentially the same as the layout of the print version of the publication from whose files it was created. The digital publication can be said to be a replica of the print version. Herein after, this initial layout is referred to as original print layout. In some implementations, user interface elements may have been added to the digital brochure 101 such as a navigation bar 102 and links. In other implementations, user interface elements can be added at later stages of the process. The desktop has a background image 103, menu bar 104, and other standard features. As is known in the art, the desktop may also include windows, icons, and other elements (not shown). For clarity purposes, the exemplary digital publication 101 is displayed in a windowless mode. In other words, the window and menu of the application running the digital brochure application (e.g. browser window, electronic document reader window, digital brochure player window, desktop publishing application, etc) is not shown to the user. In some implementations, digital publications can be displayed inside a window or in fullscreen mode whereby the desktop is no longer visible. The digital publication interface features a navigation bar 102 which includes several menu items and buttons for operating the publication. The navigation bar 102 may be positioned anywhere on the screen. In some embodiments, the digital publication 101 navigation bar 102 is optional. In other implementations, the navigation bar 102 can be dragged by user to any position on the screen. The screenshot illustrates a two-page view whereby two pages 113 114 of the digital publication are shown in a facing-page setup. In this example, page number two (113) and page number three (114) of the digital publication are displayed on screen 111 112. A digital publication page 113 is typically characterized by content objects, such as text 106, images 110, video clips 115, animations, audio files and the like, and layout or formatting information which defines the organization of the content. Page numbers 111 112 can also be shown in the interface.

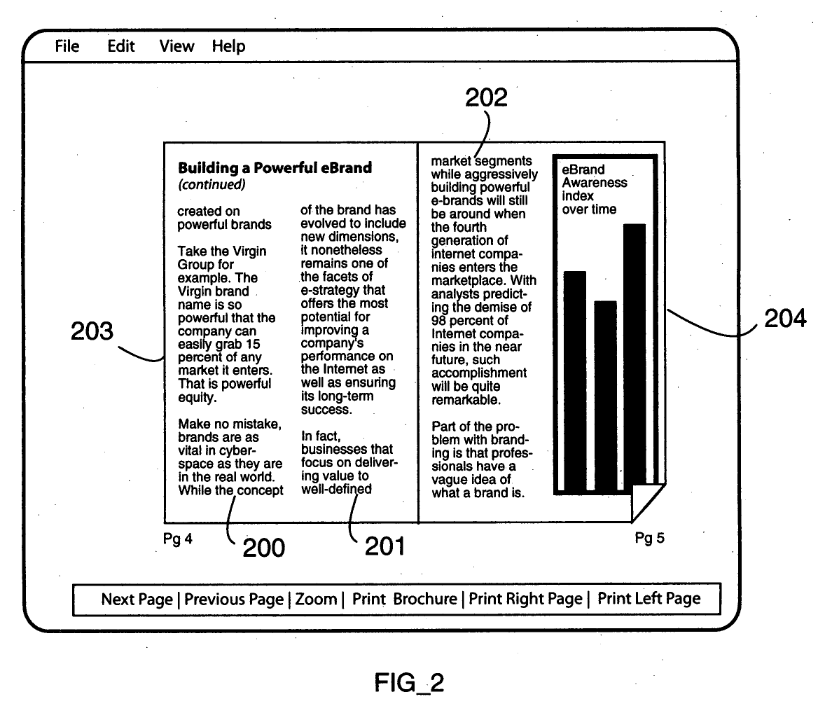

FIG. 2 shows a screenshot of subsequent pages, page number four (203) and page number five (204), of the exemplary digital publication 101 illustrated in FIG. 1.

FIGS. 1 and 2 further show an article featuring a title 105 and content spread over four subsequent pages 113 114 203 204. Textual content for the article is organized in seven columns 106 107 108 109 200 201 202. Herein after, this article is referred to as the eBranding article.

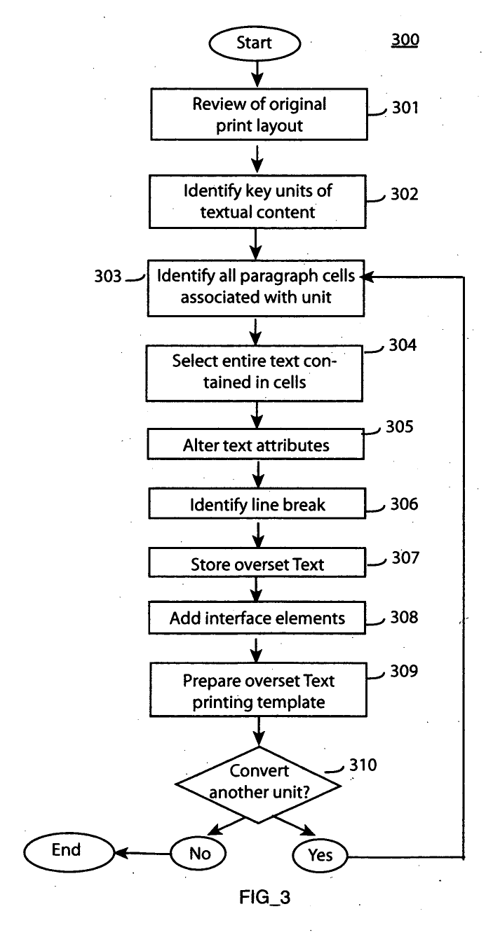

FIG. 3 illustrates a block diagram of a method 300 that may be used to convert key textual content of a print publication into a format optimized for the digital version of the publication and increase its legibility.

The method begins by analyzing the original print layout 301 and by identifying units of key (e.g. important) textual content 302. A unit of textual content can be an entire article, an entire section on a particular topic, en entire product description, etc . . . A unit can be confined to one page as in a one page article or can be spread across several continuous or non-continuous pages as in a multi-page article. For example, the eBranding article shown in FIGS. 1 and 2 represents one unit of textual content spread across multiple pages 113 114 203 204. Once all key units have been identified throughout the publication, publisher can alter each unit individually 303 310. Steps 303 310 can be repeated for each unit of key textual content. Steps 303 310 can be performed at compile time in an authoring environment or at runtime programmatically.

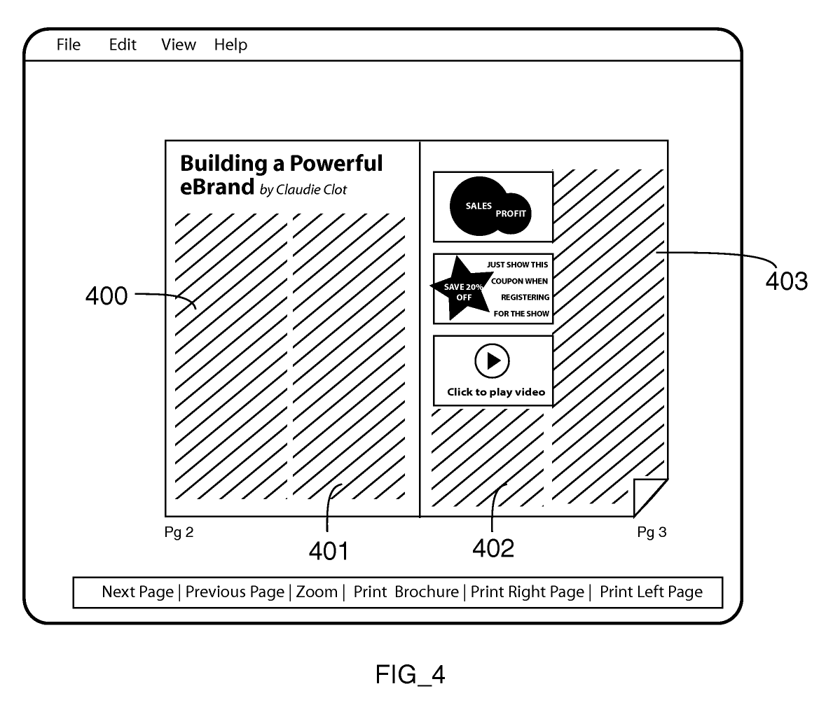

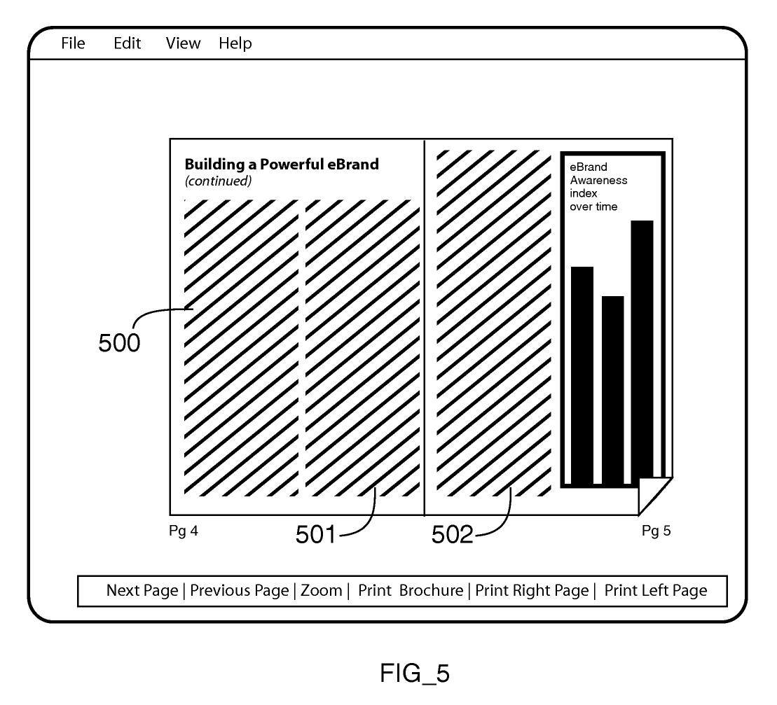

For each unit of key content, paragraph cells (e.g. text boxes, text blocks, text frames, etc) corresponding to the unit are identified 303. The combination of the paragraph cells, herein after referred to as cells, forms the space alloted to the text of the unit. Cells may already be linked to allow the text to flow during the creation of the document. The result is threaded cells. If the cells are unlinked, publisher can link all cells. FIG. 4 shows a screenshot of paragraph cells 400 401 402 403 corresponding to the eBranding article on page number two 113 and page number three 114 of the digital publication 101. FIG. 5 shows a screenshot of paragraph cells 500 501 502 corresponding to the eBranding article on page number four 203 and page number five 203 of the digital publication 101. The combination of all paragraph cells 400 401 402 403 500 501 502 represent the space allotted to the eBranding article in the digital publication 101. In some implementations, the identification of paragraph cells associated with a particular unit of content 303 can be done visually by going through the publication and determining which paragraph cells or columns belong to said unit. In other implementation said identification 303 can be done programmatically by checking for paragraph cell linkage or the tags of structured publications.

The method continues with selecting the entire text 304 contained in the cells of a given unit and increasing its font size by a value ranging from 105% to 500% depending the final effect desired 305.

Said final effect means the most appropriate combination of text attributes (e.g. font size, character spacing, word spacing, line spacing, etc . . . ) to ensure legibility of text of unit in the digital publication.

In some embodiments, publisher can make an arbitrary decision as to the selection of a value (V) between 105% and 500% and increase the font size by said value accordingly. In other implementations, publisher can perform a series of calculations to determine the most appropriate value. Such calculations begin with recording the print publication's actual dimensions (pW=width of single page and pH=height of single page), recording the digital publications final dimensions (dW=width of single page on screen and dH=height of single page on screen), and recording the font size of the text in the unit of content to be altered in the print publication (pF). If the unit features several font sizes, the smallest font size can be selected. In other implementations, the font size most prevalent throughout the unit can be selected. Other implementations are possible.

The print-to-digital (pdR) ratio can be calculated by dividing pH by dH or by dividing pW by dW. In this case, V equals pdR. In other words, the font size pF can then be multiplied by pdR to arrive at the final font size for the corresponding unit of content in the digital version. If the publisher wishes to present content in the digital publication using a larger final font size (dF), he can also proceed to calculate print-to-digital ratio for fonts (pdfR) by dividing dF by pF. To arrive at the final font size, publisher can multiply pF by pdfR and by pdR. In this case, V equals pdfR*pdR (e.g. pdfR multiplied by pdR).

In units of content where different fonts are used or different font sizes, publishers can use the same value V to increase the font size of all text by same amount. Conversely, publisher can use different values V for different fonts or different sections of text of unit to achieve various emphases.

In some implementations, the font family and or typeface may be changed to further increase legibility in the digital publication.

In some embodiments, the leading (e.g. line spacing) can also be increased between 105% to 500%. In some implementations, kerning (e.g. character spacing, word spacing) can be increased 105% to 500%.

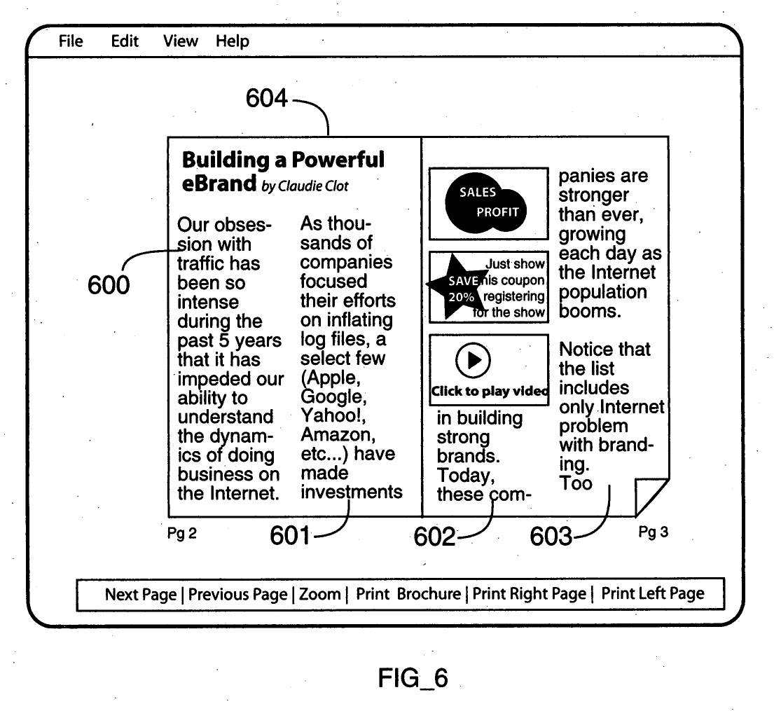

FIG. 6 shows a screenshot of the textual content of the eBrand article after increasing the font size by a V value of 145% according to one embodiment of the method. Textual content is still contained in the same unit cells 600 601 602 603 on page number two and page number three. As a result of increasing the font size or font sizes of the unit's text, the original content will be reflowed throughout the space allotted to the unit (e.g. cells). In other words, text that does not fit in the four cells 600 601 602 603 of pages two and three is reflowed to the three additional cells 500 501 502 on pages number four and five that complete the seven cells allotted to the eBrand article in the digital publication 101.

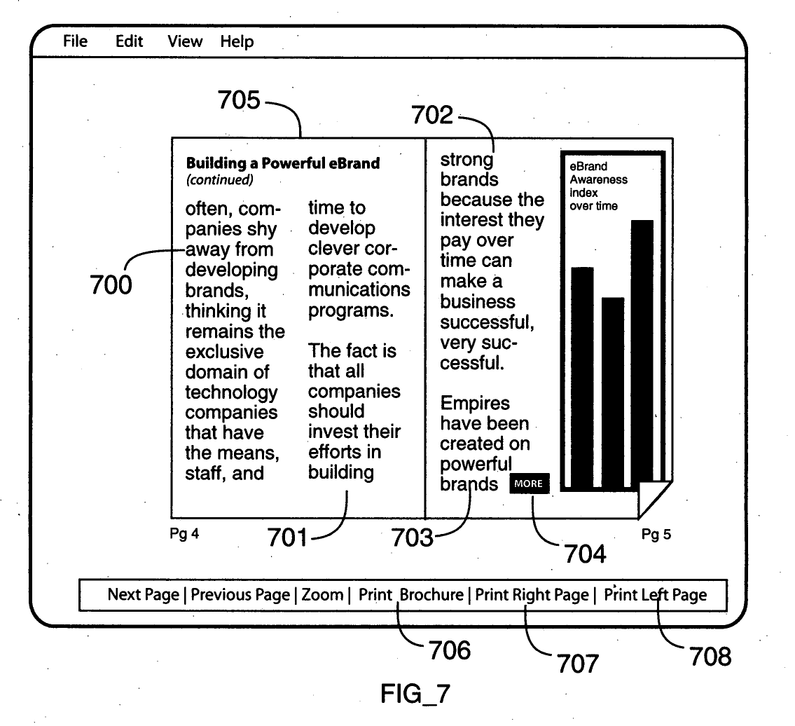

FIG. 7 shows a screenshot of textual content of the eBrand article on pages number four and five after increasing its font size by a value V of 145%. As with the previous two pages, the text is confined to the same unit cells 700 701 702 originally alloted to the eBrand article on pages number four and five of the digital publication. Textual content flows from cells 603 to 700 without interruption (e.g. breaks).

As it is typeset using a larger font size, the text overflows; in other words, the entire textual content (e.g. text) can no longer fit in the original allotted space 106 107 108 109 200 201 202. The portion of text that does not fit is often referred to as overset text.

The method then involves identifying the last cell of the unit's threaded cells and noting the last line of text displayed in the box 306. This becomes the line break 703.

The overset text includes the first character positioned right after the last character of the line break up 703 (e.g. “s”) to the last character or punctuation symbol of the unit text. In one implementation, the overset text can be stored in a variable 307. In other embodiments, the overset text can be turned into a graphical element to be displayed to the user. Said graphical element can be a graphic representing a rasterized version of the overset text.

To provide the reader access to the overset text, a user interface element 704 is inserted next to the line break 703. Said element can be textual such as a link (e.g. “more” or “continue”) or a graphical element such as a button 704. Reader can activate display of overset text by clicking on the element 704. Other methods of activation are possible. In some implementations, the user can invoke the display of the overset text by moving its cursor over a button or link, by hitting a designated keyboard function key or key combination after placing the cursor on the unit of content; by invoking a contextual menu for the unit by hitting a designated keyboard function key or key combination or clicking on a mouse button. Other more straightforward methods are also possible whereby the user makes use of a special tool in the navigation bar 102 of the digital publication interface or the system interface, or the digital publication reader application's interface to display the overset text of a particular unit by clicking on it. In other embodiments, the user can execute a specific mouse or input device movement on screen to invoke the display of the overset text for a particular unit. For example, the user can shake the mouse over a section of content; the engine analyzes in real-time the x and y coordinates of the cursor to determine whether a special motion has been detected.

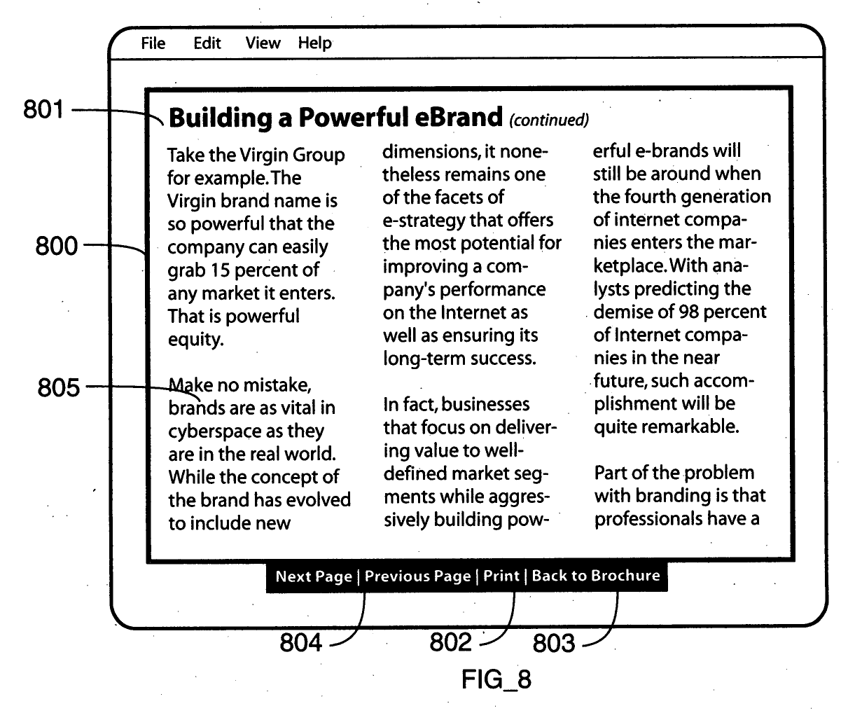

FIG. 8 illustrates a screenshot of a user interface that may be used to display overset text and allow reader to interact with the overset text.

In response to user input, a new object 800 is displayed over the digital publication 101 or next to the digital publication. In some embodiments, said object can replace digital publication. Said object 800 can feature the overset text 805 to allow user to continue reading the content of the unit. The object can also feature the title of the article 801. The overset text 805 can be displayed graphically by presenting a rasterized version of the overset text 805 on top of the object 800 or the overset text variable can populate text boxes positioned on top of the object 800. In other implementations, a pane, dialog or popup window can be used to display the overset text 805 instead of an object 800.

Each object 800 can feature user interface elements 802 803 804 such as Previous/Next buttons 804 to access sections of overset text when the overset text 805 cannot be displayed in its entirety at once. Other interface elements can include Print Overset buttons 802 designed to only print the overset text and Back to publication button 803.

The method continues with the preparation of an optimized printing template 309 for the unit of content to ensure that the reader can enjoy the best printing options at all times during the reading experience. The printing process is explained in details below.

The method concludes 310 when all key units of content of the publication have been converted. If the publisher wishes to convert other units, steps 303 310 are repeated with a new unit of content.

### Printing Process

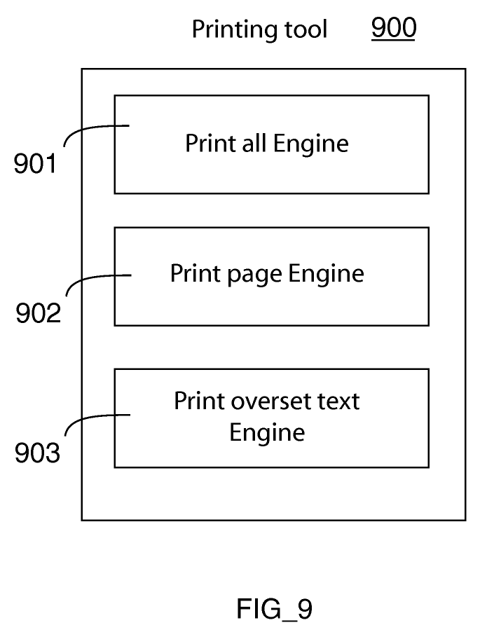

FIG. 9 illustrates a block diagram of a printing tool 900 that can be used to print an optimized digital publication 604 705.

Printing of an optimized digital publication 604 705 can be instantiated using a printing tool 900 which can include a Print All Engine 901, a Print Page Engine 902 and a Print Overset Text Engine 903.

Engines are communicatively coupled to one or more of each other. Though the engines identified above are described as being separate or distinct, one or more of the engines may be combined in a single process or routine. The functional description provided herein including separation of responsibility for distinct functions is exemplary. Other groupings or other divisions of functional responsibilities can be made as necessary or in accordance with design preferences.

As used herein, the terms “process” and “engines” refer to a combination of functions, subroutines, procedure, subprogram, and the like that can be implemented in hardware, software, firmware or the like. The processes can be separate processes or combined in another process. All can be a separate applications that are executable.

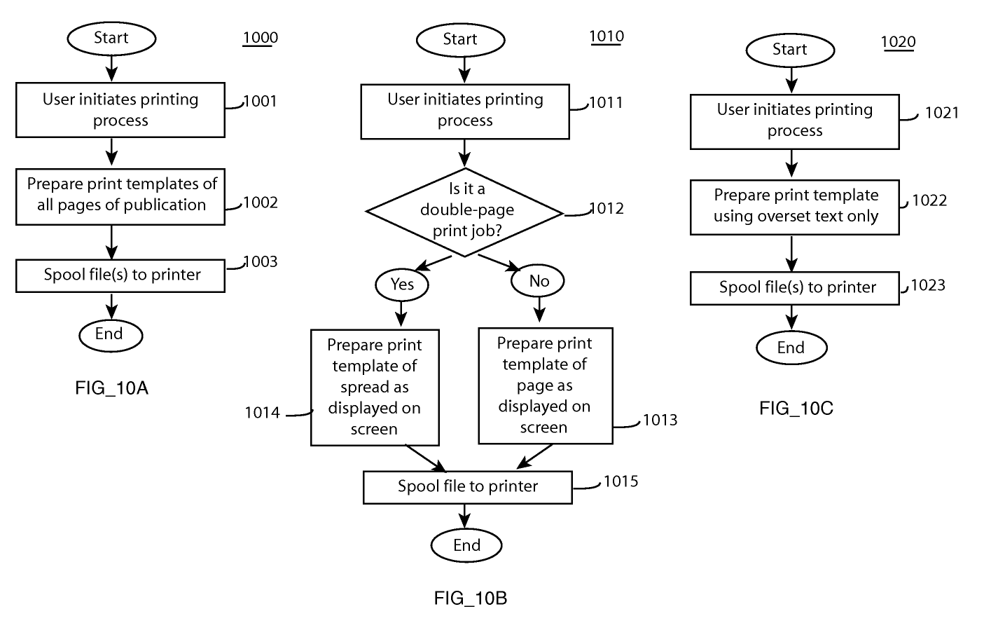

FIGS. 10A 10B 10C describe methods 1000 1010 1020 that may be used to print the content of said optimized digital publication 604 705. The methods may be performed, at least in part, on the user's own processing device or on a remote server.

The methods begin by receiving the user input 1000 1010 1020 to print the content of the optimized digital publication 604 705. The user can invoke a printing engine 901 902 903 by clicking a print button 706 707 708 802 in the digital brochure interface. In some embodiments, the print button may be located in the digital brochure navigation bar 102 or system interface 104, on a page of the brochure, etc . . . In other embodiments, the user can invoke the printing engines 901 902 903 by hitting a designated keyboard function key or key combination after placing the cursor on the page or section to be printed; by invoking a contextual menu for the page or section to be printed by hitting a designated keyboard function key or key combination or clicking on a mouse button. Herein after the aforementioned invocation methods are referred as printing invocation methods.

In some implementations of the invention, only one print button may be presented to the reader. In response to user input, the Printing tool 900 determines which printing engine will handle the user request. The printing tool 900 may display a dialog window prompting user to select whether she wants to print the entire brochure, just a page or the overset text. Based on user input, the Printing tool 900 will invoke the Print all Engine 901, the Print page Engine 902, or the Print overset text Engine 903 respectively.

In another embodiment, several print buttons 706 707 708 802 may be displayed to the reader in the digital publication interface. In one embodiment, the navigation bar may feature a print all 706, print page 708, and print text button 802. Each button would provide user input as to which printing engine will be invoked. Similarly, such choices can be made available in a contextual menu. In another embodiment, the different print buttons may only be displayed as appropriate. For instance, the Print overset text 802 button may only be shown when the overset text layer 800 is displayed on screen.

FIG. 10A illustrates a block diagram of a method 1000 that may be used by the Print All Engine 901 to print all the pages of the digital publication 101. The method begins when the user invokes 1001 the Print All engine 901 using one of the print invocation methods described above. In response to user input, the Print All Engine 901 proceeds to prepare the print files (e.g. print templates) 1002 that will be sent to the printer. Preparation can be realized at runtime or at compile time. Said print files can be pre-built in the publication file, loaded from a remote server, or built locally on the user's processing device. The preparation of print files involves reverting back to the original text settings found in the print publication. In other words, even though the optimized (e.g. reformatted) pages are displayed on screen to facilitate legibility, the Print All Engine will send the original (e.g. unformatted) page format from the print publication to the printer. In some embodiments, the templates are defined at authoring time. In other embodiments, the templates are built programmatically at runtime whereby the text of key units of content is altered so that its attributes revert to the attributes prior to optimization 303 310. In other implementations of the invention, part of the templates can be built at compile time and part during runtime.

In other embodiments, the Print All engine will also handle requests to print a range of pages. The same method 1000 is used for selected pages.

The method continues as the print files are spooled to the user's printer 1003.

FIG. 10B illustrates a block diagram of a method 1010 that may be used by the Print Page Engine 902 to print a page of the digital publication. The method begins when the user invokes 1011 the Print Page Engine 902 using one of the print invocation methods described above. In response to user input, the Print Page Engine 902 determines whether the requested page is part of a double-page spread where key content is displayed across two facing pages 1012. Double-page spreads featuring key content spread across two pages may be identified through a variable associated with the number of the page displayed on screen. The Print Page Engine 902 checks for value of the variable to determine how to prepare the print templates of the pages. A value of 0 means regular single page print; a value of 1 means double-page print.

If printing a double-page spread 1014, the Print Page Engine 902 combines the two pages so that they can be printed as one page on one sheet of Letter-size or A4-size paper. Other paper size can be used in some implementations of the invention. If printing a single page, the Print Page Engine 902 will proceed to include only the requested page 1013 in the print template to be sent to the printer. The preparation of the print templates for both steps 1013 1014 include leaving the format of the pages as they are displayed on screen unchanged. The dimensions of the pages may be altered to fit the sheet of paper, however the layout is not altered and text attributes are not reverted to their original settings as in method 1000. In other words, reformatted text from 310 is incorporated in the print templates. Print templates can be pre-built in the publication file, loaded from a remote server, or built locally on the user's processing device. In some embodiments, the templates are defined at authoring time. In other embodiments, the templates are built programmatically at runtime.

In some implementations of the invention, steps 1012 1013 can be optional. In other words, the Print Page Engine 902 will make no attempt to combine double-page spreads. Instead, the Print Page Engine 902 will proceed directly to step 1014 upon receiving user input 1011.

The method 1010 continues with the Print Page Engine 902 spooling the print templates to the printer 1015.

FIG. 10C illustrates a block diagram of a method 1020 that may be used by the Print Overset Text Engine 903 to print a overset text from a key unit of content of the digital publication. The method begins when the user invokes 1021 the Print Overset Text Engine 902 using one of the print invocation methods described above. In response to user input, the Print Overset Text Engine 903 prepares the print template featuring the overset text only. In some implementations, the overset text printed may be the text contained in the layer 800 presented to the user only. In other implementation, the entire overset text for a particular unit may be printed. Print templates can be pre-built in the publication file, loaded from a remote server, or built locally on the user's processing device. In some embodiments, the templates are defined at authoring time. In other embodiments, the templates are built programmatically at runtime by accessing the variable used to store the overset text and populating text fields in the print templates.

The method 1020 continues with the Print Overset Text Engine 903 spooling the print templates to the printer 1023.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense. For instance, instead of reformatting a unit of content across its entire allocated space as described above, reformatting can take place at the page level or double-page spread level. In other words, textual content for the unit can be reflowed across the paragraph cells featured on a page. An interface element can be placed next to the last line of text visible on the page. The last line marking the line break for the page. The overset text for the page contains the character after the last character of the line break up until the last character of the text visible on the page before reformatting. Subsequent pages can be altered similarly until the entire unit of content has been optimized. The printing tool 900 may handle printing using methods 1000 1010 1020. In other embodiments, the printing tool may combine methods 1000 1010 1020 to output print templates of the original, unformatted publication pages when the reader decides to print a page or the entire publication. The print overset engine may handle the overset printing.

1. A method for optimizing the layout and printing of pages of digital publications to improve the legibility of key content without materially altering the position and size of the bounding boxes of the content elements featured on the pages, the method comprising the steps of: analyzing the original layout as defined in the print publication on which the digital publication is based, identifying key units of textual content; for each unit of key textual content: identifying all paragraph cells associated with the unit of textual content, selecting entire text contained in paragraph cells, altering property attributes of selected text, identifying line break, storing overset text, adding interface elements to enable full interactivity with all content, preparing printing templates.

2. The method of claim 1 wherein the property attributes of selected text is at least one of: font size, character spacing, word spacing, line spacing, or typeface.

3. The method of claim 1 wherein altering the property attributes of selected text comprises at least one of: increasing its font size by a value ranging from 105% to 500%, increasing the line spacing by a value ranging from 105% to 500%, or increasing character spacing by a value ranging from 105% to 500%.

4. The method of claim 3 wherein determining the value of the font size increase comprises at least one of: A) arbitrarily selecting a value between 105% and 500% based on desired final effect, or B) performing calculations comparing the print publication's dimensions to the digital publication's dimensions.

5. The method of claim 4 wherein desired final effect comprises the most appropriate combination of property attributes to ensure legibility of text of unit in the digital publication.

6. The method of claim 4 wherein performing calculations further comprises: recording the print publication's actual dimensions, namely the width of single page (pW) and

7. The method of claim 6 wherein calculating the publication's print-to-digital ratio further comprises at least one of: A) dividing pH by dH or B) pW by dW.

8. The method of claim 6 wherein recording the font size comprises at least one of: A) recording the smallest font size of a group of font sizes used in the unit of content or B) recording the font size most prevalent throughout the unit of content.

9. The method of claim 4 wherein performing calculations further comprises: calculating print-to-digital ratio for fonts (pdfR) by dividing the desired final font size (dF) by pF, multiplying pF by pdfR and by pdR, and increasing the font size by a value approximating pdfR multiplied by pdR.

10. The method of claim 1 wherein altering the property attributes of selected text comprises: increasing all font sizes within the unit of content by the same value or increasing the font sizes by different values to achieve special emphases.

11. The method of claim 1 wherein identifying the line break further comprises the steps of: identifying the last cell of the key unit's threaded cells and recording the last line of text displayed in said cell.

12. The method of claim 1 wherein overset text includes all characters between the first character positioned right after the last character of the line break to the last character or punctuation symbol of the unit text.

13. The method of claim 1 wherein storing overset text further comprises at least one of: storing overset text in a variable or turning into a graphical element to be displayed to the user.

14. The method of claim 13 wherein graphical element is a rasterized version of the overset text.

15. The method of claim 1 wherein adding interface elements to enable full interactivity with all content further comprises: inserting textual or graphical link next to the line break to provide access to overset text.

16. A method for providing a user interface for presentation of overset text on the display of the processing device, the user interface including elements to facilitate user interaction with content.

17. The method of claim 16 wherein providing a user interface further comprises at least one of: presenting an object superimposed over the digital publication, presenting an object next to the digital publication, presenting an object which replaces the digital publication, presenting the title of the key unit of content, presenting text objects populated with overset text variable, presenting rasterized version of overset text, presenting navigation interface elements.

18. The method of claim 17 wherein presenting navigation interface elements further comprises: presenting textual or graphical links to enable user to access sections, presenting textual or graphical links to print overset text, presenting textual or graphical links to return to the digital publication.

19. A method for printing digital publications comprising the steps of: receiving user input, selecting appropriate printing engine, determining whether to print a page or a double-page spread, preparing printing templates.

20. The method of 19 wherein receiving user input further comprises: detecting whether user wants to print a page, to print all pages or to print the overset text.

21. The method of 19 wherein preparing printing templates further comprises: using templates pre-built during compile time, loading templates from a remote server, using templates built at run-time on user's processing device.

22. The method of 19 wherein preparing printing templates further comprises: determining whether page is part of a double-page spread where key content is displayed across two facing pages.

23. The method of claim 22 wherein determining whether page is part of a double-page spread where key content is displayed across two facing pages comprises the steps of: checking the value of variable associated with given page numbers.

24. The method of 19 wherein preparing printing templates further comprises at least one of: A) preparing templates using the text property attributes of key units of content after optimization when user selects print page option, B) preparing templates using the original text property attributes of key units of content prior to optimization when user selects print all option, C) preparing templates using two facing pages resized to fit on one sheet of Letter-size or A4-size paper when user chooses to print a page featuring key content spread out over two facing pages, D) preparing templates using the entire overset text or a portion of the overset text when user chooses the print the overset text displayed on screen.

25. A system comprising means for optimizing the layout and printing of pages of digital publications to improve the legibility of key content without materially altering the position and size of the bounding boxes of the content elements featured on the pages, the further comprising means for analyzing the original layout as defined in the print publication on which the digital publication is based, means for identifying key units of textual content; for each unit of key textual content: means for identifying all paragraph cells associated with the unit of textual content, means for selecting entire text contained in paragraph cells, means for altering property attributes of selected text, means for identifying line break, means for storing overset text, means for adding interface elements to enable full interactivity with all content, means for preparing printing templates.

26. A system comprising means for providing a user interface for presentation of overset text on the display of the processing device, the user interface including elements to facilitate user interaction with content.

27. A system comprising means for printing digital publications, the system further comprising the means for: receiving user input, selecting appropriate printing engine, determining whether to print a page or a double-page spread, preparing printing templates.

28. A computer program product comprising instructions to cause a computing device to: optimize the layout and printing of pages of digital publications to improve the legibility of key content without materially altering the position and size of the bounding boxes of the content elements featured on the pages, the computer program product further comprising instructions to cause a computing device to : analyze the original layout as defined in the print publication on which the digital publication is based, identify key units of textual content; for each unit of key textual content: to identify all paragraph cells associated with the unit of textual content, to select entire text contained in paragraph cells, to alter property attributes of selected text, to identify line break, to store overset text, to add interface elements to enable full interactivity with all content, to prepare printing templates.

29. A computer program product comprising instructions to cause a computing device o: provide a user interface for presentation of overset text on the display of the processing device, the user interface including elements to facilitate user interaction with content.

30. A computer program product comprising instructions to cause a computing device to: print digital publications, the computer program product comprising instructions to cause a computing device to: receive user input, to select appropriate printing engine, to determine whether to print a page or a double-page spread, to prepare printing templates.
